(19) United States
(12) Patent Application Publication
(10) Pub. No.: US 2025/0094014 A1
(43) Pub. Date: Mar. 20, 2025

(54) DISPLAY DEVICE AND CONTROL METHOD THEREOF

(71) Applicant: LG ELECTRONICS INC., Seoul (KR)

(72) Inventor: Seunghyun HEO, Seoul (KR)

(73) Assignee: LG ELECTRONICS INC., Seoul (KR)

(21) Appl. No.: 18/729,365

(22) PCT Filed: Feb. 18, 2022
(86) PCT No.: PCT/KR2022/002441

§ 371 Date: Jul. 16, 2024

(51) Int. Cl. G06F 3/04812; G06F 3/0346; G06F 3/0354; H04N 21/422; H04N 21/431

(52) U.S. Cl. CPC G06F 3/04812; G06F 3/0346; G06F 3/03543; H04N 21/42222; H04N 21/4316; G06F 2203/0384

(57) ABSTRACT

An embodiment provides a display device comprising: a display module through which content is output; an interface unit which communicates with a remote control device; and a control unit, wherein the control unit receives data from the remote control device, determines a mode of the remote control device on the basis of information included in the data, and converts the data into coordinate values on the basis of the mode of the remote control device.

### TECHNICAL FIELD

The present disclosure relates to a display device for providing content to a user.

### BACKGROUND

With the increasing development of information society, the demand for display devices is also increasing in various forms. In response to this trend, various display devices, for example, Liquid Crystal Display (LCD), Field Emission Display (FED), Plasma Display Panel (PDP), an electroluminescent device, etc. have recently been developed.

A liquid crystal panel of the LCD may include a liquid crystal layer, may further include a thin film transistor (TFT) substrate and a color filter substrate that are arranged to face each other on the basis of the liquid crystal panel interposed therebetween, and may display an image using light provided from a backlight unit.

As an example of an electroluminescent device, active-matrix-type organic light emitting display (OLED) devices are commercially available on the market and widely used throughout the world. Since the OLED device is a self-emitting device, the OLED device has no backlight and is advantageous in terms of a response speed and a viewing angle as compared to the LCD, so that the OLED devices are attracting attention as next-generation displays.

Additionally, recently, the display device may output an application that includes various items rather than simply outputting broadcast content corresponding to a received broadcast signal.

In this case, it is difficult to select a small item using a commonly used remote controller.

### SUMMARY

### Technical Problem

The present disclosure is to provide a display device and a method for controlling the same that convert a coordinate value based on a mode of a remote controller to solve the above problem.

### Technical Solutions

An embodiment provides a display device including a display module that outputs content thereon, an interface unit that is in communication with a remote controller, and

a controller, wherein the controller receives data from the remote controller, determines a mode of the remote controller based on information included in the data, and converts the data into a coordinate value based on the mode of the remote controller.

The data may include x-axis data, y-axis data, z-axis data, roll rotation data, pitch rotation data, and yaw rotation data.

The controller may delete the z-axis data, the pitch rotation data, and the yaw rotation data among the data when the mode of the remote controller is determined to be a first mode, and delete the x-axis data and the roll rotation data among the data when the mode of the remote controller is determined to be a second mode.

The controller may determine the mode of the remote controller as the first mode when values of the roll rotation data, the pitch rotation data, the yaw rotation data, and the z-axis data among the information included in the data are 0.

The controller may output a guide pop-up window when the content being output is included in a first category, wherein the guide pop-up window guides switching the mode of the remote controller to the first mode.

The controller may output the guide pop-up window when a virtual keyboard is output while the content is being output.

The controller may output the guide pop-up window when the number of items included in the content being output is equal to or greater than a first number.

The controller may output a first user interface on the content when the mode of the remote controller is the first mode, and output a second user interface on the content when the mode of the remote controller is the second mode, wherein the first user interface includes a larger number of items than the second user interface.

The controller may set a movement speed of a cursor output on the content based on the remote controller to a first speed when the mode of the remote controller is the first mode, and set the movement speed of the cursor output on the content based on the remote controller to a second speed when the mode of the remote controller is the second mode, wherein the first speed is higher than the second speed.

An embodiment provides a method for controlling a display device including a display module that outputs content thereon, wherein the display device includes an interface unit that is in communication with a remote controller and a controller, wherein the method including receiving data from the remote controller, determining a mode of the remote controller based on information included in the data, and converting the data into a coordinate value based on the mode of the remote controller.

### Advantageous Effects

The display device in the present disclosure may use the single remote controller in the two modes. Accordingly, the user may more accurately select the item that is difficult to select with the general remote controller among the items being displayed on the display device.

Effects that may be obtained from the present disclosure are not limited to the effects mentioned above, and other effects not mentioned will able to be clearly understood by those skilled in the art in the technical field to which the present disclosure belongs from the description below.

### BRIEF DESCRIPTION OF THE DRAWINGS

FIG. 1 is a block diagram illustrating constituent elements of a display device according to an embodiment of the present disclosure.

FIG. 2 is a diagram showing a remote controller according to an embodiment of the present disclosure.

FIG. 3 is a block diagram illustrating an operation of a display device according to an embodiment of the present disclosure.

FIG. 4 is a block diagram illustrating an operation of a mode recognition module according to an embodiment of the present disclosure.

FIG. 5 is a block diagram illustrating an operation of a coordinate filter module according to an embodiment of the present disclosure.

FIGS. 6 to 8 are diagrams illustrating an embodiment of outputting a guide pop-up window on a display device according to an embodiment of the present disclosure.

FIG. 9 is a diagram illustrating an embodiment of outputting a different user interface based on a mode of a remote controller on a display device according to an embodiment of the present disclosure.

FIG. 10 is a diagram illustrating an embodiment of outputting a user interface that appears when using a remote controller in a mouse mode on a display device according to an embodiment of the present disclosure.

FIG. 11 is a diagram illustrating an embodiment of controlling a movement speed of a cursor in a display device according to an embodiment of the present disclosure.

FIG. 12 is a diagram showing a flowchart of a method for controlling a display device according to an embodiment of the present disclosure.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

On the other hand, the image display device described herein is, for example, an intelligent image display device implemented by adding a computer support function to a broadcast reception function, and further includes an Internet function or the like while sufficiently performing the broadcast reception function, so that the image display device may have user-friendly interfaces such as a handwriting input device, a touchscreen, or a spatial remote controller. Further, the image display device can support a wired or wireless Internet function by connecting to the Internet and a computer device, thereby performing e-mailing, web browsing, banking, or gaming. To implement these functions, the image display device may operate based on a standard general-purpose Operating System (OS).

Accordingly, the image display device according to the present disclosure is designed in a manner that various applications can be easily added to or deleted from a general-purpose OS kernel so that the image display device can perform various user-friendly functions. The image display device may be, for example, a network TV, a Hybrid broadcast broadband TV (HBBTV), a smart TV, etc. The image display device is applicable to a smartphone as needed.

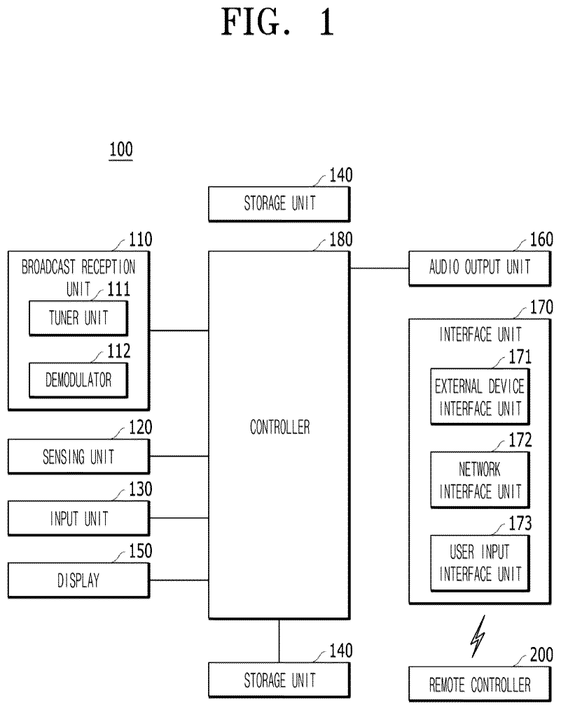

FIG. 1 is a block diagram illustrating constituent elements of a display device 100 according to an embodiment of the present disclosure.

Referring to FIG. 1, the display device 100 may include a broadcast reception unit 110, an external device interface unit 171, a network interface unit 172, a storage unit 140, a user input interface unit 173, an input unit 130, a controller 180, a display 150, an audio output unit 160, and/or a power-supply unit 190.

The broadcast reception unit 110 may include a tuner unit 111 and a demodulator 112.

Although not shown in the drawings, the display device 100 may include only the external device interface unit 171 and the network interface unit 172 from among the broadcast reception unit 110, the external device interface unit 171, and the network interface unit 172. That is, the display device 100 may not include the broadcast reception unit 110.

The tuner unit 111 may select a broadcast signal corresponding to either a user-selected channel or all prestored channels from among broadcast signals received through an antenna (not shown) or a cable (not shown). The tuner unit 111 may convert the selected broadcast signal into an intermediate frequency (IF) signal or a baseband image or a voice signal.

For example, when the selected broadcast signal is a digital broadcast signal, the tuner unit 111 may convert the selected broadcast signal into a digital IF (DIF) signal. When the selected broadcast signal is an analog broadcast signal, the tuner unit 111 may convert the selected broadcast signal into an analog baseband image or a voice signal (CVBS/SIF). That is, the tuner unit 111 may process the digital broadcast signal or the analog broadcast signal. The analog baseband image or the voice signal (CVBS/SIF) output from the tuner unit 111 may be directly input to the controller 180.

The tuner unit 111 may sequentially select broadcasting signals of all broadcasting channels stored through a channel memory function from among the received broadcast signals, and may convert the selected broadcast signal into an intermediate frequency (IF) signal or a baseband image or a voice signal.

The tuner unit 111 may include a plurality of tuners to receive broadcast signals of the plurality of channels. Alternatively, a single tuner for simultaneously receiving broadcast signals of the plurality of channels is also possible.

The demodulator 112 may receive the digital IF signal (DIF) converted by the tuner unit 111, and may thus perform demodulation of the received signal. The demodulator 112 may perform demodulation and channel decoding, and may output a stream signal (TS). The stream signal may be a signal formed by multiplexing an image signal, a voice signal, or a data signal.

The stream signal (TS) output from the demodulator 112 may be input tio the controller 180. The controller 180 may perform demultiplexing, image/audio signal processing, etc., may output an image through the display 150, and may output a voice through the audio output unit 160.

The sensing unit 120 may sense a change in the display device 100 or may sense an external change. For example, the sensing unit 120 may include a proximity sensor, an illumination sensor, a touch sensor, an infrared (IR) sensor, an ultrasonic sensor, an optical sensor (e.g., a camera), a voice sensor (e.g., a microphone), a battery gauge, environmental sensors (e.g., hygrometer, a thermometer, etc.).

The controller 180 may check a state of the display device 100 based on information collected by the sensing unit 120, may notify the user of a problem, or may control the display device 100 to be kept in the best state.

In addition, it is possible to provide an optimal viewing environment by differently controlling the content, image quality, size, etc. of the image provided to the display module 180 depending on the viewer, ambient illuminance, etc. sensed by the sensing unit. As the smart TV has evolved, the number of functions mounted in the display device increases, and the number of the sensing units 20 also increases together with the increasing functions.

The input unit 130 may be provided at one side of a main body of the display device 100. For example, the input unit 130 may include a touch pad, a physical button, and the like. The input unit 130 may receive various user commands related to the operation of the display device 100, and may transmit a control signal corresponding to the input command to the controller 180.

Recently, as a bezel of the display device 100 decreases in size, the number of display devices 100 each including a minimum number of input unit 130 formed in a physical button exposed to the outside is rapidly increasing. Instead, a minimum number of physical buttons may be provided on the back or side surface of the display device 100. The display device may receive a user input through the remote controller 200 through a touchpad or a user input interface unit 173 to be described later.

The storage unit 140 may store a program for processing and controlling each signal used in the controller 180, and may store a signal-processed image, a voice, or a data signal. For example, the storage unit 140 may store application programs designed for the purpose of performing various tasks that can be processed by the controller 180, and may selectively provide some of the stored application programs upon request of the controller 180.

The program stored in the storage unit 140 is not specifically limited to being executed by the controller 180. The storage unit 140 may perform a function for temporarily storing an image, a voice, or a data signal received from an external device through the external device interface unit 171. The storage unit 140 may store information about a predetermined broadcast channel through a channel memory function such as a channel map.

Although the storage unit 140 of FIG. 1 is provided separately from the controller 180, the scope of the present disclosure is not limited thereto, and the storage unit 140 may also be included in the controller 180 as needed.

The storage unit 140 may include at least one of a volatile memory (e.g., DRAM, SRAM, SDRAM, etc.) and a non-volatile memory (e.g., flash memory, hard disk drive (HDD), solid state drive (SSD), etc.).

The display 150 may generate a drive signal by converting an image signal, a data signal, an OSD signal, a control signal processed by the controller 180, or by converting an image signal, a data signal, a control signal, etc. received from the interface unit 171. The display 150 may include a display panel 181 having a plurality of pixels.

A plurality of pixels included in the display panel may include RGB sub-pixels. Alternatively, a plurality of pixels included in the display panel may include sub-pixels of RGBW. The display 150 may convert the image signal, the data signal, the OSD signal, the control signal, etc. processed by the controller 180 to generate a drive signal for the plurality of pixels.

The display 150 may be implemented as a plasma display panel (PDP), a liquid crystal display (LCD), an organic light emitting diode (OLED), a flexible display, etc. In addition, the display 150 may also be implemented as a three-dimensional (3D) display. The three-dimensional (3D) display 150 may be classified into a glassless-type 3D display and a glasses-type 3D display.

The display device may include a display module that occupies most parts of the front surface, and a case that covers the back and side surfaces of the display module and packages the display module.

Recently, the display device 100 has evolved from a flat-screen display to a curved-screen display. In order to implement the curved screen, the display device 100 may use a display module 150 that can be bent or curved, such as a light emitting diode (LED) or an organic light emitting diode (OLED), etc.

Conventionally, the LCD has difficulty in self-emitting light, so that the conventional LCD has been designed to receive light through a backlight unit. The backlight unit is a device for uniformly supplying light received from a light source to a liquid crystal located on the front surface of the display device. As the backlight becomes thinner, a thin LCD can be implemented. However, it is actually difficult for the backlight unit to be implemented as a curved structure formed of a flexible material. Although the backlight unit is implemented as a curved shape, it is difficult for light to be uniformly applied to the liquid crystal, thereby changing brightness of the screen.

On the other hand, the LED or the OLED is designed in a manner that each of constituent elements constructing the pixels can self-emit light without using the backlight unit, so that the LED or the OLED can be implemented as a curved shape without any problems. In addition, since each element can perform self-emission of light, brightness of each element is not affected by a change in the positional relationship between the element and adjacent elements, so that a curved display module 150 can be implemented as an LED or OLED.

OLED (Organic Light Emitting Diode) panels appeared in earnest in mid-2010 and are rapidly replacing LCDs in the small-and medium-sized display market. The OLED is a display made using the self-emission characteristics in which OLED emits light when a current flows in a fluorescent organic compound. Since the response speed of the OLED is faster than that of the LCD, there is little afterimage when moving images are implemented.

OLEDs may be used as a light-emitting display product. In this case, the light-emitting display device may use three fluorescent organic compounds (such as red, green, and blue) each having a self-emitting function, and may use the self-emitting phenomenon in which positive (+)-charged particles and electrons injected from a cathode and anode are combined with each other within the organic material, so that a backlight unit causing degradation of color sense need not be used.

The LED panel is implemented by technology for using only one LED element as one pixel, and has a smaller LED element compared to the prior art, so that a curved display module 150 can be implemented. Whereas the conventional device referred to as an LED TV can use the LED as a light source of the backlight unit for supplying light to the LCD, it is impossible for the LED of the conventional device to constitute a screen.

The display module may include a display panel, a coupling magnet located on the rear surface of the display panel, a first power-supply unit, and a first signal module. The display panel may include a plurality of pixels (R, G, B). The plurality of pixels (R, G, B) may be formed in each region where a plurality of data lines and a plurality of gate lines cross each other. The plurality of pixels (R, G, B) may be arranged in a matrix.

For example, the plurality of pixels (R, G, B) may include a red (R) sub-pixel, a green (G) sub-pixel, and a blue (B) sub-pixel. The plurality of pixels (R, G, B) may further include white (W) sub-pixel(s).

In the display module 150, one side where an image is displayed may be referred to as a front side or a front surface. When the display module 150 displays an image, one side where no image is observed may be referred to as a rear side or a rear surface.

Meanwhile, the display 150 may be implemented as a touchscreen, so that the display 150 can also be used as an input device in addition to an output device.

The audio output unit 160 may receive a voice-processed signal from the controller 180, and may output the received signal as a voice signal.

The interface unit 170 may serve as a path of connection to various kinds of external devices connected to the display device 100. The interface unit may include not only a wired method for transmitting/receiving data through a cable, but also a wireless method using the antenna.

The interface unit 170 may include at least one of a wired/wireless headset port, an external charger port, a wired/wireless data port, a memory card port, a port connected to a device having an identification module, an audio input/output (I/O) port, a video I/O port, and an earphone port.

As an example of a wireless method, the above-described broadcast reception unit 110 may be used. The broadcast reception unit 110 may be configured to use a broadcast signal, a mobile communication short-range communication signal, a wireless Internet signal, and the like.

The external device interface unit 171 may transmit or receive data to and from a connected external device. To this end, the external device interface unit 171 may include an A/V input/output (I/O) unit (not shown).

The external device interface unit 171 may be wired or wirelessly connected to an external device such as a digital versatile disc (DVD) player, a Blu-ray player, a game console, a camera, a camcorder, a computer (laptop), a set-top box, or the like, and may perform an input/output (I/O) operation with the external device.

In addition, the external device interface unit 171 may establish a communication network with various remote controllers 200, may receive a control signal related to operation of the display device 100 from the remote controller 200, or may transmit data related to operation of the display device 100 to the remote controller 200.

The external device interface unit 171 may include a wireless communication unit (not shown) for short-range wireless communication with other electronic devices. Through the wireless communication unit (not shown), the external device interface unit 171 may exchange data with an adjacent mobile terminal. In particular, the external device interface unit 171 may receive device information, application information, an application image, and the like from the mobile terminal in a mirroring mode.

The network interface unit 172 may provide an interface for connecting the display device 100 to a wired/wireless network including the Internet network. For example, the network interface unit 172 may receive content or data provided by the Internet, a content provider, or a network administrator through a network. The network interface unit 172 may include a communication module (not shown) for connection with the wired/wireless network.

The external device interface unit 171 and/or the network interface unit 172 may include a communication module for short-range communication such as Wi-Fi, Bluetooth, Bluetooth low energy (BLE), ZigBee, Near Field Communication (NFC), and a communication module for cellular communication such as Long-Term Evolution (LTE), LTE-A (LTE Advanced), Code Division Multiple Access (CDMA), WCDMA (wideband CDMA), UMTS (universal mobile telecommunications system), WiBro (Wireless Broadband), etc.

The user input interface unit 173 may transmit user input signals to the controller 180, or may transmit signals received from the controller 180 to the user. For example, the user input interface unit 173 may transmit or receive user input signals (such as a power-on/off signal, a channel selection signal, and a screen setting signal) to and from the remote controller 200, may transmit user input signals received through a local key (not shown) such as a power key, a channel key, a volume key, and a setting key to the controller 180, may transmit a user input signal received by a sensor unit (not shown) for sensing a user gesture to the controller 180, or may transmit a signal received from the controller 180 to the sensor unit.

The controller 180 may include at least one processor, and may control the overall operation of the display device 100 using the processor included therein. Here, the processor may be a general processor such as a CPU. Of course, the processor may be a dedicated device such as an ASIC, or other hardware-based processor.

The controller 180 may demultiplex the stream received through the tuner unit 111, the demodulator 112, the external device interface unit 171, or the network interface 172, and may process the demultiplexed signals to generate and output a signal for image or voice output.

The image signal processed by the controller 180 may be input to the display 150 and displayed as an image corresponding to the corresponding image signal. In addition, the image signal processed by the controller 180 may be input to the external output device through the external device interface unit 171.

The voice (or audio) signal processed by the controller 180 may be audibly output to the audio output unit 160. In addition, the voice signal processed by the controller 180 may be input to the external output device through the external device interface unit 171.

In addition, the controller 180 may control the overall operation of the display device 100. For example, the controller 180 may control the tuner unit 111 to select a broadcast program corresponding to either a user-selected channel or a prestored channel.

In addition, the controller 180 may control the display device 100 by a user command or an internal program received through the user input interface unit 173. The controller 180 may control the display 150 to display an image. In this case, the image displayed on the display 150 may be a still image or a moving image, and may be a 2D image or a 3D image.

On the other hand, the controller 180 may display a predetermined 2D object in the image displayed on the display 150. For example, the object may be at least one of a connected web screen (newspaper, magazine, etc.), electronic program guide (EPG), various menus, widgets, icons, still images, moving images, and text.

Meanwhile, the controller 180 may modulate and/or demodulate the signal using an amplitude shift keying (ASK) scheme. Here, the ASK scheme may refer to a method for modulating a signal by differentiating the amplitude of a carrier wave according to data values or for restoring an analog signal to a digital data value according to the amplitude of the carrier wave.

For example, the controller 180 may modulate an image signal using the ASK scheme, and may transmit the modulated signal through a wireless communication module.

For example, the controller 180 may demodulate and process the image signal received through the wireless communication module using the ASK scheme.

Accordingly, the display device 100 may simply transmit and receive signals to and from other image display devices arranged adjacent to each other without using either a unique identifier such as a Media Access Control (MAC) address or a complex communication protocol such as TCP/IP.

On the other hand, the display device 100 may further include a photographing unit (not shown). The photographing unit may photograph a user. The photographing unit may be implemented as one camera, but is not limited thereto, and may be implemented by a plurality of cameras. On the other hand, the photographing unit may be embedded in the display device 100 or may be separately arranged on the display 150. The image information photographed by the photographing unit may be input to the controller 180.

The controller 180 may recognize the position of the user based on the image photographed by the photographing unit. For example, the controller 180 may recognize a distance (z-axis coordinates) between the user and the display device 100. In addition, the controller 180 may recognize the X-axis coordinate and the Y-axis coordinate within the display 150 corresponding to the user position.

The controller 180 may sense a user gesture based on an image photographed by the photographing unit, each of signals detected by the sensor unit, or a combination thereof.

The power-supply unit 190 may supply corresponding power to the display device 100. In particular, the controller 180 may be implemented as a System on Chip (SoC), a display 150 for displaying an image, and an audio output unit 160 for audio output.

Specifically, the power-supply unit 190 may include a converter (not shown) for converting AC power into DC power, and a DC/DC converter (not shown) for converting the level of DC power.

On the other hand, the power-supply unit 190 may receive power from the external power source, and may distribute the received power to the respective components. The power-supply unit 190 may be directly connected to the external power source to supply AC power, and may include a battery capable of being charged with electricity.

In the former case, the power-supply unit 190 may be used by connecting to a wired cable, and it is difficult for the power-supply unit 190 to move from one place to another place, and the movement range of the power-supply unit 190 is limited. In the latter case, the power-supply unit 190 can move from one place to another place, but the weight and volume of the power-supply unit 190 may increase as much as the weight and volume of the battery. In addition, for charging, the power-supply unit 190 should be directly connected to a power cable for a predetermined period of time or should be coupled to a charging cradle (not shown) for power supply.

The charging cradle may be connected to the display device through a terminal exposed to the outside. Alternatively, if the power-supply unit 190 approaches the charging cradle using a wireless interface, a built-in battery of the power-supply unit 190 may also be charged with electricity.

The remote controller 200 may transmit a user input to the user input interface unit 173. To this end, the remote controller 200 may use Bluetooth, Radio Frequency (RF) communication, infrared (IR) communication, Ultra-Wideband (UWB), ZigBee, or the like. In addition, the remote controller 200 may receive the image, voice, or data signal output from the user input interface unit 173, and may display or audibly output the received image, voice, or data signal.

On the other hand, the above-described display device 100 may be a fixed or mobile digital broadcast receiver capable of receiving digital broadcast signals.

Meanwhile, the block diagram of the display device 100 shown in FIG. 1 is disclosed for only for illustrative purposes for one embodiment of the present disclosure, and the respective components of the display device 100 shown in FIG. 1 can be integrated, added or omitted according to the specifications of the digital device 100 which is actually implemented.

That is, if necessary, two or more components may be combined into one component, or one component may be subdivided into two or more components. In addition, the functions performed in each block are intended to explain the embodiment of the present disclosure, and the specific operation or device does not limit the scope of the present disclosure.

Among the remote controllers for controlling the display device, a magic remote controller may provide a user experience that goes beyond simply issuing a command to watch content. However, when using the magic remote controller, operation may be sufficient for a simple application, but selection may be difficult when items are disposed in various user interfaces across a screen. This is because commercially available magic remote controllers are used in air, making it difficult to specifically select items in a small user interface.

Therefore, in an embodiment of the present disclosure, the magic remote controller may not be used only in air, but may be placed on a horizontal place such as a floor or a table and used like a mouse, thereby taking advantages of a remote controller with a cursor and improving convenience of use.

To this end, an embodiment of the present disclosure seeks to apply a different coordinate recognition method for each mode of the remote controller.

When using the remote controller on the floor, an operation method of the cursor changes to resemble that of the mouse. That is, x-axis data and y-axis data values may be recognized, and a coordinate value of the cursor output on the content may be calculated based on the x-axis data and y-axis data values.

In addition, when using the remote controller in air, the operation method of the cursor changes to resemble that of the magic remote controller. That is, the coordinate value of the cursor output on the content may be calculated based on y-axis data and z-axis data values.

Additionally, an embodiment that distinguishes a mode in which the remote controller is being used may be applied beforehand.

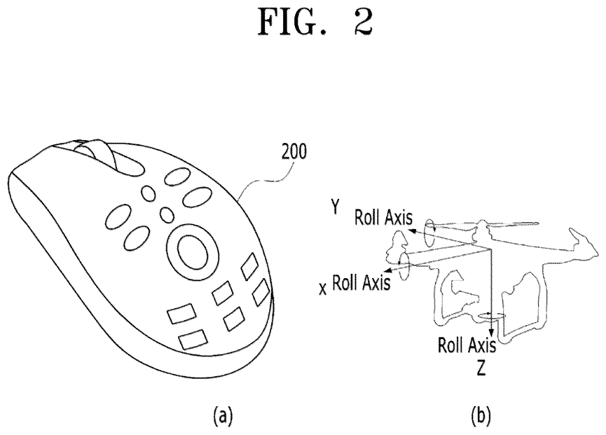

FIG. 2 is a diagram showing a remote controller according to an embodiment of the present disclosure. Hereinafter, content that is duplicated with the above description will be omitted.

Referring to (a) in FIG. 2, the remote controller 200 for controlling the display device may be manufactured in a form of the mouse as shown in FIG. 2. That is, the user may not only control the display device by holding the remote controller 200 in air, but may also control the display device by placing the remote controller 200 on the horizontal place such as the floor or the table.

Additionally, the typical remote controller 200 may include a 6-axis gyro sensor. Accordingly, the remote controller 200 may obtain the x-axis data, the y-axis data, the z-axis data, roll rotation data, pitch rotation data, and yaw rotation data and transmit the data to the display device.

In an embodiment, the display device may analyze the data received from the remote controller 200 and use the remote controller 200 in one of a first mode (hereinafter, a mouse mode) or a second mode (hereinafter, a remote controller mode).

In other words, the user may use the single remote controller 200 in the two ways, and the display device may differently apply the method for recognizing the coordinate values or differently output the user interface based on the mode of the remote controller 200.

Referring to (b) in FIG. 2, the remote controller 200 according to an embodiment may include a 3-axis gyro sensor and a 3-axis acceleration sensor, which together are also referred to as a 6-axis gyro sensor, to recognize a 3-dimensional space. Additionally, the remote controller 200 may recognize a tilt for each axis using the 3-axis gyro sensor and the 3-axis acceleration sensor.

In this regard, the x-axis data, the y-axis data, the z-axis data, the roll rotation data, the pitch rotation data, and the yaw rotation data to be described later are based on (b) in FIG. 2. In other words, because standards for the x-axis data, the y-axis data, and the z-axis data are differently defined depending on a field, they are defined as shown in (b) in FIG. 2 in the present disclosure.

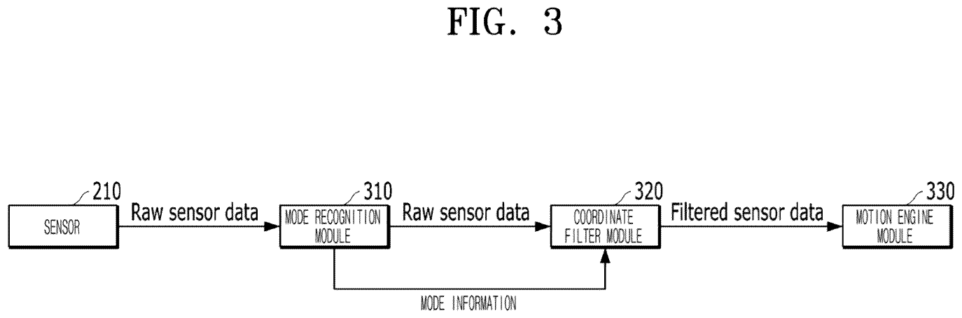

FIG. 3 is a block diagram illustrating an operation of a display device according to an embodiment of the present disclosure. Hereinafter, content that is duplicated with the above description will be omitted.

Referring to FIG. 3, the display device according to an embodiment of the present disclosure may further include a mode recognition module 310, a coordinate filter module 320, and a motion engine module 330 in addition to the content described above in FIG. 1. In this regard, the mode recognition module 310, the coordinate filter module 320, and the motion engine module 330 may operate within the controller 180 described above in FIG. 1. However, the mode recognition module 310, the coordinate filter module 320, and the motion engine module 330 are components for simply illustrating respective functions thereof and are not limited to names thereof.

More specifically, the display device may receive the data from a sensor 210 of the remote controller described above in FIG. 2. In this regard, the data may correspond to raw sensor data. In other words, this may mean all original data collected by the sensor 210 of the remote controller. In an embodiment, the data may include the x-axis data, the y-axis data, the z-axis data, the roll rotation data, the pitch rotation data, and the yaw rotation data.

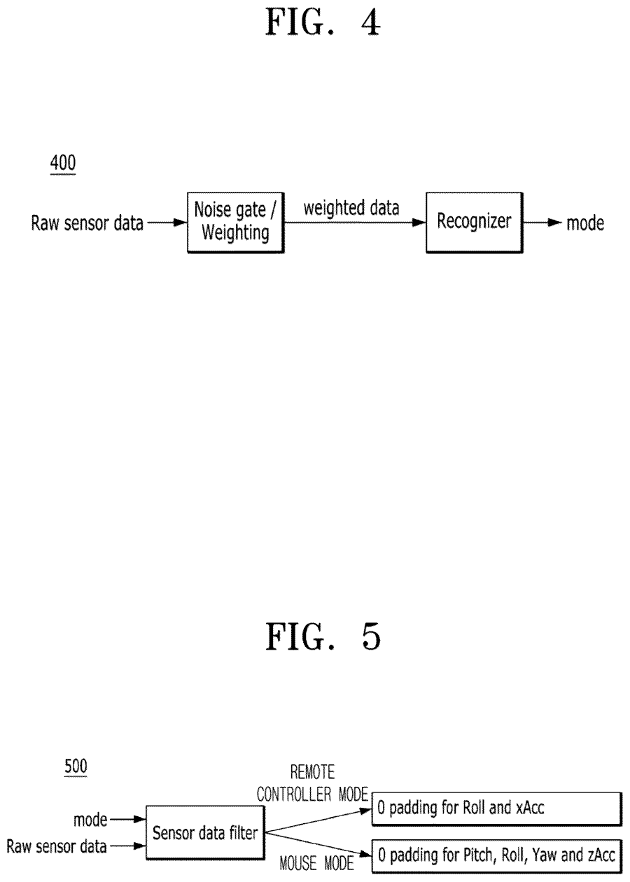

The mode recognition module 310 may determine the mode of the remote controller based on information included in the received data. The mode recognition module 310 may transmit the received data to the coordinate filter module 320, and at the same time, inform the coordinate filter module 320 of the determined mode of the remote controller. The mode recognition module 310 will be described in detail in FIG. 4 below.

The coordinate filter module 320 may convert the received data based on the mode of the remote controller. More specifically, the coordinate filter module 320 may convert the received data based on whether the remote controller is in the mouse mode or in the remote controller mode. The coordinate filter module 320 may transmit filtered sensor data to the motion engine module 330. The coordinate filter module 320 will be described in detail in FIG. 5 below.

The motion engine module 330 may convert the sensor data into a coordinate value based on the received filtered sensor data. When the sensor data is converted into the coordinate value via the motion engine module 330, the display device may output, via the display module, the cursor corresponding to a movement of the remote controller based on the coordinate value.

FIG. 4 is a block diagram illustrating an operation of a mode recognition module according to an embodiment of the present disclosure. Hereinafter, content that is duplicated with the above description will be omitted.

Referring to FIG. 4, a mode recognition module 400 may determine which mode the remote controller is being used in using received data (raw sensor data).

More specifically, the mode recognition module 400 may determine whether the remote controller is moving by being placed on the horizontal place or moving in air based on the received data.

To this end, the mode recognition module 400 may assign a weight to the received data via a noise gate and a weighting module. In an embodiment, the noise gate is a gate that removes noise by lowering an output level when an input data level is equal to or lower than a certain critical value. Additionally, contrary to the operation of the noise gate, the weighting module may assign the weight to the output level when the input data level is equal to or higher than the certain critical value, allowing the data to be determined more reliably.

Accordingly, the weighted data may be transmitted to a recognizer. The recognizer may determine the mode of the remote controller based on the received data.

More specifically, when the remote controller is moving while being placed on the horizontal place, there will be no z-axis data because the noise gate has been passed through, and there will also be no rotation data or tilt data value. In this case, when the received data has a z-axis data value of 0 and a rotation data value or a tilt data value of 0, the recognizer may determine the mode of the remote controller to be the mouse mode. Additionally, in an embodiment, the recognizer may determine that the mode is the mouse mode when a 3-axis tilt data value is 0 and a z-axis acceleration data value is maintained at 9 among the received data.

On the other hand, when the remote controller is moving in air, a y-axis data value and a z-axis data value will be received to be great because the weighting module has been passed through. In this case, when the received data has the relatively great y-axis data value and z-axis data value compared to other data values, the recognizer may determine the mode of the remote controller to be the remote controller mode.

When the mode of the remote controller is determined via the recognizer, the mode recognition module 400 may transmit the determined mode of the remote controller to the coordinate filter module 320 described above in FIG. 3.

FIG. 5 is a block diagram illustrating an operation of a coordinate filter module according to an embodiment of the present disclosure. Hereinafter, content that is duplicated with the above description will be omitted.

Referring to FIG. 5, a coordinate filter module 500 may receive the mode of the remote controller and the data (the raw sensor data) via FIGS. 3 and 4. In this regard, the coordinate filter module 400 may receive the initial raw sensor data rather than the data from which the noise has been removed or to which the weight has been given. This is to obtain the accurate coordinate value using the more accurate data.

Based on the mode of the remote controller, the coordinate filter module 500 may leave only necessary data values among the original data and pad the remaining data values with 0. In other words, the coordinate filter module 500 may remove the noise by leaving only the necessary data values among the original data and setting the unnecessary data values to 0 based on the mode of the remote controller.

More specifically, when the mode of the remote controller is the mouse mode, the coordinate filter module 500 may change the pitch rotation data value, the yaw rotation data value, and the z-axis data value to 0. In an embodiment, when the mode of the remote controller is the mouse mode, the coordinate filter module 500 may delete the z-axis data, the pitch rotation data, and the yaw rotation data among the original data.

Likewise, when the mode of the remote controller is the remote controller mode, the coordinate filter module 500 may change the roll rotation data value and the x-axis data value to 0. In an embodiment, when the mode of the remote controller is the remote controller mode, the coordinate filter module 500 may delete the x-axis data and the roll rotation data among the original data.

Thereafter, the coordinate filter module 500 may transmit the filtered data to the motion engine module 330 in FIG. 3.

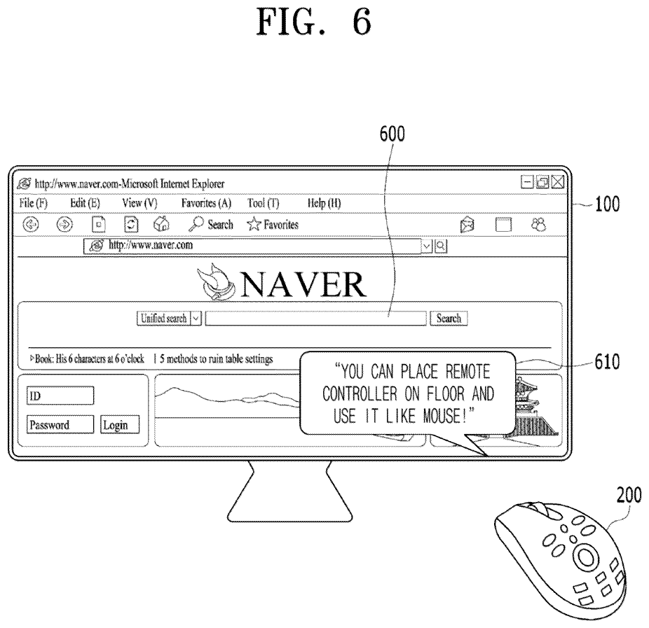

FIGS. 6 to 11 illustrate a display device that operates differently based on a mode of a remote controller determined via the above-described embodiment.

FIGS. 6 to 8 are diagrams illustrating an embodiment of outputting a guide pop-up window on a display device according to an embodiment of the present disclosure. Hereinafter, content that is duplicated with the above description will be omitted.

Additionally, FIGS. 6 to 8 illustrate an embodiment of outputting the guide pop-up window for switching the mode of the remote controller on the display device based on specific conditions. In this regard, the display device may automatically switch the mode of the remote controller based on the specific conditions disclosed in FIGS. 6 to 8. However, in FIGS. 6 to 8 below, only the embodiment of outputting the guide pop-up window will be described.

Referring to FIG. 6, the display device 100 may output a guide pop-up window 610 when content 600 being output from the display module is content included in a first category.

More specifically, the display device 100 may receive information on the content 600 being output. In this regard, the information on the content 600 may include application identification information. The application identification information may indicate whether an application is a web browser or the like. Additionally, the information on the content 600 may include HTML code information.

The display device 100 may determine whether the content 600 is the content included in the first category based on the information on the content 600 being output. In this regard, the first category corresponds to a set of the content 600 in which the remote controller 200 is mainly used in the mouse mode. In an embodiment, the display device 100 may receive information on the first category from the outside. Additionally, the display device 100 may store the information on the first category in a memory. The first category may include a mode of the remote controller 200 that is mainly used by the user for each application. For example, in the case of the web browser application, the first category may include information indicating that the user uses the remote controller 200 in the mouse mode, while in the case of a video playback application, the first category may include information indicating that the user uses the remote controller 200 in the remote controller mode.

Accordingly, the display device 100 may output the guide pop-up window 610 when the content 600 being output is the content included in the first category. In this regard, the guide pop-up window 610 may guide switching the mode of the remote controller 200 to first mode. For example, the guide pop-up window 610 may include a text “You can place the remote controller on the floor and use it like a mouse!”.

In other words, when the remote controller 200 is more convenient in the mouse mode to control the content 600 being output, the display device 100 may guide the user to use the remote controller 200 in the mouse mode. Thereafter, as the guide pop-up window 610 is output, when the user places the remote controller 200 on the floor and uses the same, according to the embodiment in FIGS. 3 to 5, the display device 100 may recognize the remote controller 200 to be in the mouse mode and output the coordinate value.

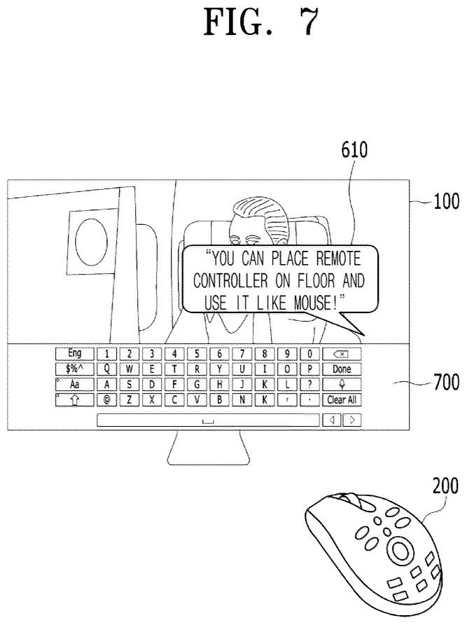

Referring to FIG. 7, when a virtual keyboard 700 is output from the display module, the display device 100 may output the guide pop-up window 610 described above in FIG. 6.

More specifically, when the virtual keyboard 700 is output during the content output, the display device 100 may output the guide pop-up window 610. In this regard, the virtual keyboard 700 may be output by a user request or by a request from the content being output.

When the virtual keyboard 700 is output, an input to the virtual keyboard 700 may be easier when the remote controller 200 is placed on the floor and used in the mouse mode than when the remote controller 200 is used in air in the remote controller mode.

Therefore, the display device 100 may output the guide pop-up window 610 to the user based on the output of the virtual keyboard (700), thereby inducing the user to use the remote controller 200 in the mouse mode.

When the user places the remote controller 200 on the floor and used the same based on the guide pop-up window 610, the display device 100 may recognize the remote controller 200 to be in the mouse mode and output the coordinate value according to the embodiment in FIGS. 3 to 5.

When the remote controller 200 operates in the mouse mode, the user may perform the input to the virtual keyboard 700 more accurately.

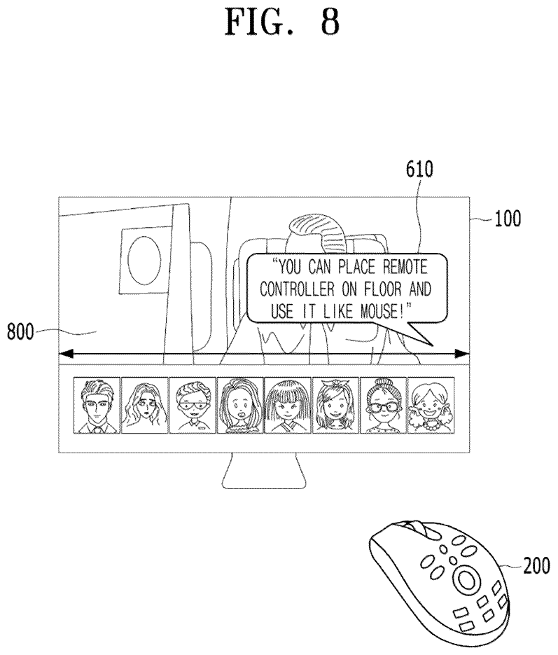

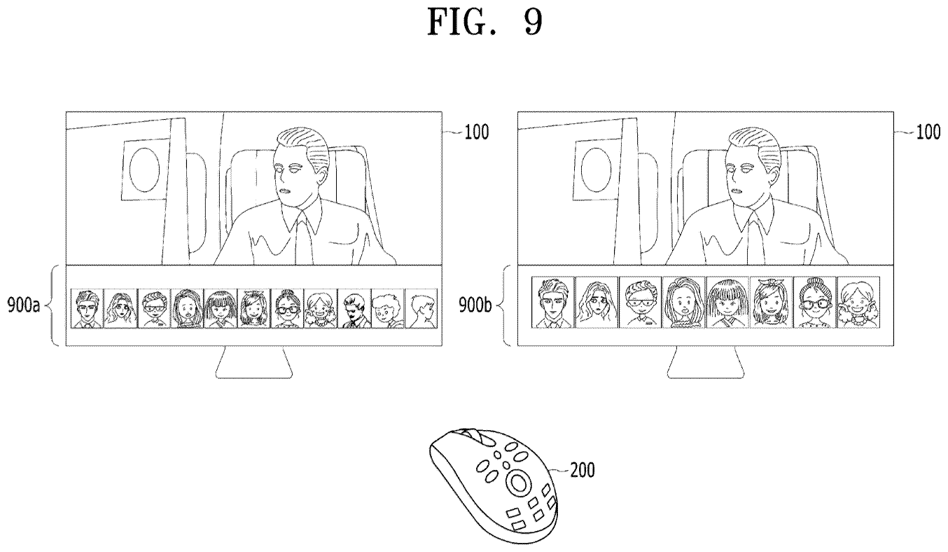

Referring to FIG. 8, the display device 100 may output the guide pop-up window 610 when the number of items included in content 800 being output is equal to or greater than a first number.

More specifically, the display device 100 may determine the number of items included in the content 800. In this regard, the number of items corresponds to the number of clickable or focusable items for each unit area.

For example, the display device 100 may determine that the number of clickable or focusable items is 8 when a width of the content 800 is 1920. In this case, the display device 100 may output the guide pop-up window 610 based on a formula below.

if (1920/8) >threshold then changeMode ()

Here, a threshold may be determined based on results learned from the display

device 100 or another device. In an embodiment, the threshold may correspond to a fixed value. That is, when the number of items included in the content 800 is equal to or greater than 1 for each unit area, the display device 100 may output the guide pop-up window 610 for changing the mode of the remote controller 200.

In an embodiment, the display device 100 may output the guide pop-up window 610 when a spacing between the items included in the content 800 being output is narrow.

More specifically, the display device 100 may determine the spacing between the items included in the content 800.

In this case, the display device 100 may output the guide pop-up window 610 based on a formula below.

if (ItemWidth<x&&Itemwidth/10>ItemGap)

In other words, the display device 100 may output the guide pop-up window 610 when the item has a size equal to or smaller than a certain size and the spacing between the items is equal to or smaller than a certain gap.

FIG. 9 is a diagram illustrating an embodiment of outputting a different user interface based on a mode of a remote controller on a display device according to an embodiment of the present disclosure. Hereinafter, content that is duplicated with the above description will be omitted.

Recently, as the number of products applying a high-resolution panel to small inches has increased, the users use relatively small system user interfaces. Accordingly, a gap between clickable or focusable items included in the user interface becomes smaller.

In this case, when using the mouse mode of the remote controller 200, as in an embodiment of the present disclosure, the user may select the item more accurately.

Hereinafter, in the embodiment in FIG. 9, a case in which the display device 100 has received a control signal requesting the output of the user interface from the remote controller 200 is assumed. Here, the user interface refers to a user interface corresponding to the content. For example, when the user selects a home menu button of the remote controller 200 while watching the content, the display device 100 may output a user interface including an item representing information of other content related to the content as a thumbnail image.

Referring to FIG. 9, when the remote controller 200 is in the mouse mode, the display device 100 outputs a first user interface 900a on the content, and when the remote controller 200 is in the remote controller mode, the display device 100 outputs a second user interface 900b on the content, but the first user interface 900a has a larger number of items included therein than the second user interface 900b.

More specifically, the display device 100 may determine that the remote controller 200 is in the mouse mode according to the above-described embodiment. Accordingly, the display device 100 may output the first user interface 900a including the first number of items on the content being output. In this regard, the number of items included in the first user interface 900a may correspond to a width of the display module divided by a horizontal length of an item with a minimum size that the remote controller 200 may select in the mouse mode.

On the other hand, the display device 100 may determine that the remote controller 200 is in the remote controller mode according to the above-described embodiment.

Accordingly, the display device 100 may output the second user interface 900b including the second number of items on the content being output. In this regard, the number of items included in the second user interface 900b may correspond to the width of the display module divided by a horizontal length of an item with a minimum size that the remote controller 200 may select in the remote controller mode.

In other words, the remote controller 200 may select the smaller item in the mouse mode than in the remote controller mode. Accordingly, the display device 100 may include more items in the user interface that is output when the user uses the remote controller 200 in the mouse mode.

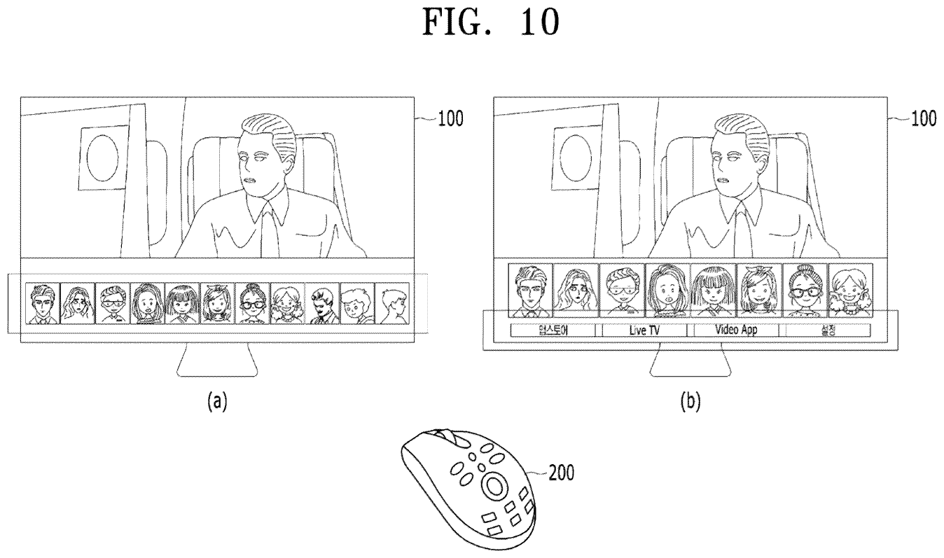

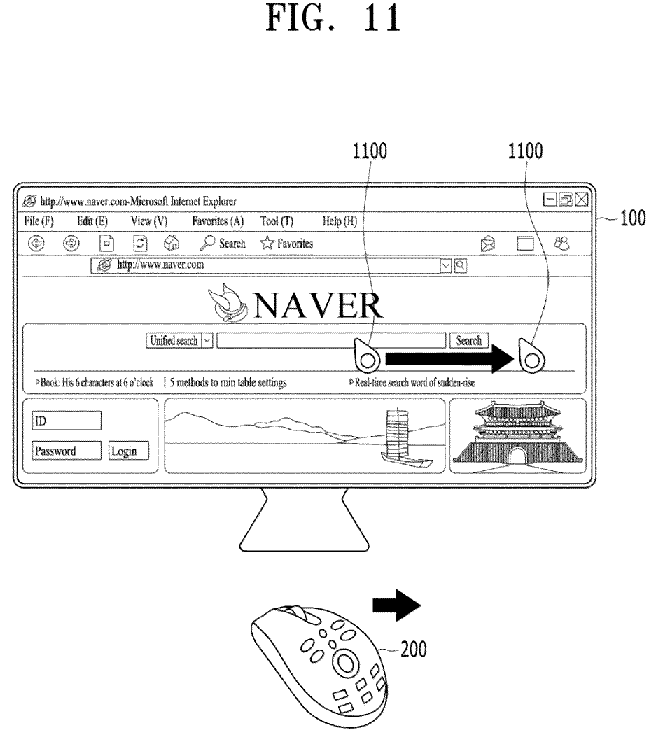

FIG. 10 is a diagram illustrating an embodiment of outputting a user interface that appears when using the remote controller 200 in the mouse mode on the display device according to an embodiment of the present disclosure. Hereinafter, content that is duplicated with the above description will be omitted.

Referring to FIG. 10, the display device 100 may sense that the user is using the remote controller 200 in the mouse mode. In an embodiment, the display device 100 may output a first user interface as shown in (a) in FIG. 10 or a second user interface as shown in (b) in FIG. 10.

Because the first user interface in (a) in FIG. 10 is the same as that in the left drawing of FIG. 9, description thereof will be omitted.

However, the second user interface in (b) in FIG. 10 corresponds to a user interface of a new style. Here, the second user interface includes the same number of items as the user interface in the right drawing in FIG. 9, but may further include a new menu item.

More specifically, the display device 100 may receive the control signal requesting the output of the user interface in the state in which the remote controller 200 is sensed to be in the mouse mode. Accordingly, the display device 100 may output the number of items output when the remote controller 200 is in the remote controller mode, as shown in the right drawing of FIG. 9. In addition, the display device 100 may further output the new menu item. In other words, the display device 100 may further output the new menu item in addition to the items in the existing user interface. In this regard, the new menu item may correspond to a different menu provided by the display device 100 rather than an item related to the content included in the existing user interface.

In other words, when the remote controller 200 is used in the mouse mode, the display device 100 may output more menu items included in the user interface as shown in (a) in FIG. 10, but may further output the menu item rather than the information related to the content according to another embodiment.

This is because when the remote controller 200 is used in the mouse mode, more items may be easily selected. In addition, this is for the display device 100 to also provide a user interface optimized for a PC rather than a user interface optimized for a TV because the remote controller 200 is used in the mouse mode.

FIG. 11 is a diagram illustrating an embodiment of controlling a movement speed of a cursor in a display device according to an embodiment of the present disclosure. Hereinafter, content that is duplicated with the above description will be omitted.

Referring to FIG. 11, when the remote controller 200 is in the mouse mode, the display device 100 may set a movement speed of a cursor 1100 output on the content based on the remote controller 200 to a first speed. Additionally, when the remote controller 200 is in the remote controller mode, the display device 100 may set the movement speed of the cursor 1100 output on the content based on the remote controller 200 to a second speed. In this regard, the first speed is higher than the second speed.

More specifically, the display device 100 may output the cursor 1100 corresponding to a movement of the remote controller 200 on the content.

In this regard, when the remote controller 200 is in the remote controller mode, the display device 100 may recognize a first coordinate value for the movement of the remote controller 200 (e.g., a value that changes from (x1, y1, z1) to (x1′, yl', z1′)). Thereafter, the display device 100 may convert the first coordinate value into a second coordinate value (a value that changes from (x2, y2, z2) to (x2′, y2′, z2′)) based on a first formula and output the second coordinate value on the display module with the cursor 1100. In this regard, to output the cursor 1100 on the display module, the z-axis data may be replaced with 0.

In an embodiment, when the remote controller 200 is in the mouse mode, the display device 100 may recognize the first coordinate value (the value that changes from (x1,y1, z1) to (x1′, y1', z1')) that is the same as the movement when the remote controller 200 is in the remote controller mode. On the other hand, the display device 100 may convert the first coordinate value into a third coordinate value (a value that changes from (x3, y3, z3) to (x3′,y3′, z3′)) based on a second formula and output the third coordinate value on the display module with the cursor 1100.

In this regard, the second formula is obtained by multiplying x, y, and z coordinate values output from the display module by ‘a’ (where ‘a’ is a positive number) when being compared to the first formula. As a result, the endpoint of the third coordinate value, (x3′,y3′, z3′), may be greater than the endpoint of the second coordinate value, (x2′, y2′, z2′).

Accordingly, the display device 100 may output the movement of the remote controller 200 in the mouse mode faster than the movement of the remote controller 200 in the remote controller mode.

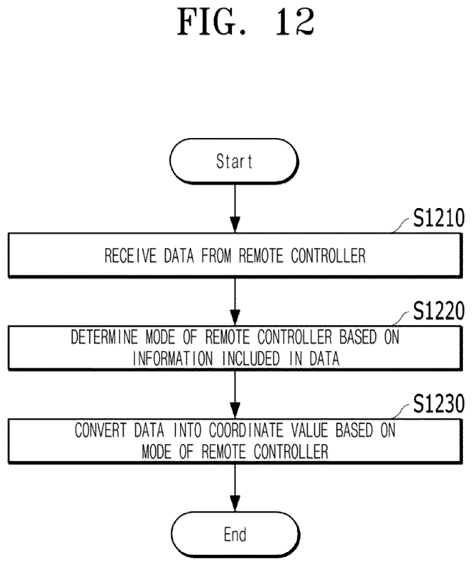

FIG. 12 is a diagram showing a flowchart of a method for controlling a display device according to an embodiment of the present disclosure. Hereinafter, content that is duplicated with the above description will be omitted.

Referring to FIG. 12, in step S1210, the display device may receive the data from the remote controller. In this regard, the data may include the x-axis data, the y-axis data, the z-axis data, the roll rotation data, the pitch rotation data, and the yaw rotation data.

In step S1220, the display device may determine the mode of the remote controller based on the information included in the data. In this regard, the mode of the remote controller may include the first mode (e.g., the mouse mode) and the second mode (e.g., the remote controller mode). In an embodiment, the display device may determine the mode of the remote controller to be the mouse mode when the rotation data and the z-axis data values among the information included in the data are 0.

In step S1230, the display device may convert the data into the coordinate value based on the mode of the remote controller. The display device may delete the z-axis data, the pitch rotation data, and the yaw rotation data among the data when the remote controller is in the mouse mode. On the other hand, the display device may delete the x-axis data and the roll rotation data among the data when the remote controller is in the remote controller mode.

In an embodiment, the display device may output the guide pop-up window that guides switching the mode of the remote controller to the mouse mode under certain conditions. In this regard, the certain conditions may include when the content being output on the display module is included in the first category, when the virtual keyboard is output, when the number of items included in the content is equal to or greater than the first number, and the like.

In another embodiment, the display device may output the first user interface on the content when the remote controller is in the mouse mode, and may output the second user interface when the remote controller is in the remote controller mode. In this regard, the first user interface has the larger number of items included therein than the second user interface.

In another embodiment, when the remote controller is in the mouse mode, the display device may set the movement speed of the cursor output on the content based on the remote controller to the first speed, and when the remote controller is in the remote controller mode, the display device may set the movement speed to the second speed. In this regard, the first speed is higher than the second speed.

In addition, in one example, the embodiments described above in FIGS. 6 to 11 may be performed in the method shown in FIG. 12.

The present disclosure may be implemented as code that can be written to a computer-readable recording medium and can thus be read by a computer. The computer-readable recording medium may be any type of recording device in which data can be stored in a computer-readable manner. Examples of the computer-readable recording medium include a hard disk drive (HDD), a solid state drive (SSD), a silicon disk drive (SDD), a ROM, a RAM, a CD-ROM, a magnetic tape, a floppy disk, optical data storage, and a carrier wave (e.g., data transmission over the Internet). In addition, the computer may include the controller. The above exemplary embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

### Industrial Applicability

The embodiments of the present disclosure relate to a display device and a method for controlling the same, and have industrial applicability because they may be repeatedly implemented.

What is claimed is:

1. A display device comprising:
a display module configured to output content thereon;
an interface unit configured to be in communication with a remote controller; and a controller,
wherein the controller is configured to:
receive data from the remote controller;
determine a mode of the remote controller based on information included in the data; and
convert the data into a coordinate value based on the mode of the remote controller.

2. The display device of claim 1, wherein the data includes x-axis data, y-axis data, z-axis data, roll rotation data, pitch rotation data, and yaw rotation data.

3. The display device of claim 2, wherein the controller is configured to:
delete the z-axis data, the pitch rotation data, and the yaw rotation data among the data when the mode of the remote controller is determined to be a first mode; and
delete the x-axis data and the roll rotation data among the data when the mode of the remote controller is determined to be a second mode.

4. The display device of claim 3, wherein the controller is configured to determine the mode of the remote controller as the first mode when values of the roll rotation data, the pitch rotation data, the yaw rotation data, and the z-axis data among the information included in the data are 0.

5. The display device of claim 4, wherein the controller is configured to output a guide pop-up window when the content being output is included in a first category, wherein the guide pop-up window guides switching the mode of the remote controller to the first mode.

6. The display device of claim 5, wherein the controller is configured to output the guide pop-up window when a virtual keyboard is output while the content is being output.

7. The display device of claim 5, wherein the controller is configured to output the guide pop-up window when the number of items included in the content being output is equal to or greater than a first number.

8. The display device of claim 3, wherein the controller is configured to:
output a first user interface on the content when the mode of the remote controller is the first mode; and
output a second user interface on the content when the mode of the remote controller is the second mode, wherein the first user interface includes a larger number of items than the second user interface.

9. The display device of claim 3, wherein the controller is configured to:
set a movement speed of a cursor output on the content based on the remote controller to a first speed when the mode of the remote controller is the first mode; and
set the movement speed of the cursor output on the content based on the remote controller to a second speed when the mode of the remote controller is the second mode, wherein the first speed is higher than the second speed.

10. A method for controlling a display device including a display module configured to output content thereon, wherein the display device includes an interface unit configured to be in communication with a remote controller and a controller, wherein the method comprising:
receiving data from the remote controller;
determining a mode of the remote controller based on information included in the data; and
converting the data into a coordinate value based on the mode of the remote controller.
